(19) United States
(12) Patent Application Publication
(10) Pub. No.: US 2009/0128110 A1
(43) Pub. Date: May 21, 2009

(54) Compact Frequency Compensation Circuit And Method For A Switching Regulator Using External Zero

(75) Inventors: Michael DeLurio, Campbell, CA (US); Charles Vinn, Milpitas, CA (US)

Correspondence Address: PATENT LAW GROUP LLP, 2635 NORTH FIRST STREET, SUITE 223, SAN JOSE, CA, 95134, US

(73) Assignee: MICREL, INC., San Jose, CA (US)

(21) Appl. No.: 11/941,341

(22) Filed: Nov. 16, 2007

(51) Int. Cl. G05F 1/00

(52) U.S. Cl. 323/282

(57) ABSTRACT

A compensation circuit in a monolithic switching regulator controller being incorporated in a closed loop feedback system of a switching regulator includes error amplifier having an output terminal with an output impedance and a degeneration resistance terminal coupled to a first terminal of the switching regulator controller. The compensation circuit includes a first resistor and a first capacitor connected in series between the output terminal of the error amplifier and a ground potential. In operation, the first capacitor and the output impedance of the error amplifier operate to introduce a pole and the first resistor and the first capacitor operate to introduce a first zero in the closed loop feedback system. When a second capacitor is coupled to the first terminal of the switching regulator controller, a second zero is introduced in the closed loop feedback system. The second capacitor is an off-chip capacitor formed external to the monolithic switching regulator controller.

### FIELD OF THE INVENTION

The invention relates to a circuit and method for providing zero compensation to a linear integrated circuit, in particular, to a circuit and method for providing compensation in a switching regulator feedback loop using an external zero.

### DESCRIPTION OF THE RELATED ART

Closed loop negative feedback systems are commonly employed in linear integrated circuits. For instance, switching regulators use a feedback loop to monitor the output voltage in order to provide regulation. To ensure stability in any closed loop system, the Nyquist criterion must be met. The Nyquist criterion states that a closed loop system is stable if the phase shift around the loop is less than 180 degrees at unity gain. Typically, a compensation circuit is added to a feedback loop to modulate the phase shift of the feedback loop to obtain stability.

The frequency response of a linear circuit can be characterized by the presence of “poles” and “zeros.” A “pole” is a mathematical term which signifies the complex frequency at which gain reduction begins. On the other hand, a “zero” signifies the complex frequency at which gain increase starts. Poles and zeros on the left half plane of a complex frequency plane or s-plane are considered normal and can be compensated. However, poles and zeros on the right half plane of a complex frequency plane are usually problematic and difficult to manipulate and is not addressed in the present application. Generally, a pole contributes a −90° phase shift while a zero contributes a +90° phase shift. A pole cancels out the phase shift of a zero for zeros in the left half plane. In designing a closed loop system with compensation, the location of the poles and zeros are manipulated so as to avoid a greater than 180° phase shift at unity gain.

In a linear circuit, poles are created by placing a small capacitor on a node with a high dynamic impedance. If the capacitor is placed at a gain stage, the capacitance can be multiplied by the gain of the stage to increase its effectiveness. Each pole has a zero associated with it. That is, at some point, the dynamic resistance of the gain stage will limit the gain loss capable of being achieved by the capacitor. Thus, a zero can be created by placing a resistor in series with the gain reduction capacitor.

A conventional voltage mode switching regulator uses an inductor-capacitor (LC) network at the voltage output terminal for filtering the regulated output voltage to produce a relatively constant DC output voltage. FIG. 1 is a schematic diagram of a conventional switching regulator including a switching regulator controller 10 and an LC circuit 11. Switching regulator controller 10 generates a switching output voltage V_{SW} at an output terminal 13 which is coupled to LC circuit 11 for providing a regulated output voltage V_{OUT}. The regulated output voltage V_{OUT} is coupled back to controller 10 at a feedback (FB) terminal 15 for forming a feedback control loop. The LC circuit has associated with it two poles, one pole associated with each element. If the feedback control loop is not compensated, LC circuit 11 alone contributes an −180° phase shift to the system and loop instability results, causing the output voltage to oscillate. Because virtually every switching regulator uses an LC filter circuit to filter the switching output voltage V_{SW}, compensation must be provided in the feedback control loop of the switching regulator to compensate for the effect of the two poles introduced by the LC circuit.

A commonly employed compensation scheme employed in switching regulators is referred to as Type III compensation. The Type III compensation scheme shapes the profile of the gain with respect to frequency using two zeroes to give a phase boost of 180°. The phase boost therefore counteracts the effects of the underdamped resonance at the double pole of the output LC filter, thereby ensuring closed loop stability.

FIG. 1 illustrates one approach for providing compensation in a feedback control loop of a switching regulator. Referring to FIG. 1, the output voltage V_{OUT} is coupled to the feedback (FB) terminal 15 through a parallel combination of a capacitor C_{zero} and a resistor R_{IN}. In some applications, a voltage divider may be provided to step down the output voltage V_{OUT} before the output voltage is fed back to the FB terminal. The feedback voltage V_{FB} is further coupled through a series combination of a resistor R_{f} and a capacitor Cₚₒₗₑ to a COMP terminal 17. COMP terminal 17 is connected to the output of the error amplifier 20 comparing the feedback voltage V_{FB} to a reference voltage.

The operation of the feedback control loop in controller 10 is well known in the art. The output voltage V_{OUT} is fed back as feedback voltage V_{FB} to error amplifier 20 which compares the feedback voltage V_{FB} to a reference voltage V_{REF}. Error amplifier 20 generates an error output signal indicative of the difference between voltage V_{FB} and reference voltage V_{REF}. The error output signal is then coupled to a comparator and other control logic to generate the drive signals for a pair of power switches. The feedback control loop of controller 10 operates to regulate the output voltage V_{OUT} based on the error output of error amplifier 20 so that voltage V_{FB} equals voltage V_{REF}.

In the switching regulator of FIG. 1, capacitor C_{zero} is connected in parallel to resistor R_{IN} and capacitor Cₚₒₗₑ is connected in series with resistor R_{f} to provide compensation to the feedback loop. Capacitor Cₚₒₗₑ and resistor R_{f} introduce a first zero in the feedback while capacitor C_{zero} and resistor R_{IN} introduces a second zero-pole pair in the feedback loop. The locations (or frequencies) of the first and second zeroes are determined by the respective resistance and the capacitance values.

FIG. 2 is a plot of the loop gain magnitude vs. frequency in log scale for the switching regulator of FIG. 1. The low frequency loop gain is first reduced by a dominant pole associated with capacitor Cₚₒₗₑ and resistor R_{IN}. The gain loss is modified by the first zero also associated with capacitor Cₚₒₗₑ and resistor R_{f} to form a midband gain region. Then, at high frequency, the second zero associated with capacitor C_{zero} and resistor R_{IN} becomes effective to increase the gain until the effect of the double-pole in the LC filter circuit causes a large loss in the loop gain. The operation of the second capacitor C_{zero} ensures that the phase shift of the feedback loop is less than 180° near unity gain.

The Type III compensation scheme for a switching regulator can be provided on-chip or off-chip. When external compensation (off-chip) is used, it is often very difficult for users of the switching regulator to determine the optimal capacitance and resistance values for capacitors Cₚₒₗₑ and C_{zero} and resistors R_{IN} and R_{f} in order to support a large range of output LC filter circuit values. The transfer function to determine the capacitance and resistance values is often very complex. When internal compensation (on-chip) is used, the range of output LC filter values is limited because the locations of the zero compensation are fixed by the on-chip compensation circuit. The LC filter circuit must conform to the limited range of inductance and capacitance values or the feedback loop will become unstable.

U.S. Pat. No. 7,170,264, entitled “Frequency Compensation Scheme For A Switching Regulator Using External Zero,” issued to Martin F. Galinski on Jan. 30, 2007, describes a compensation circuit in a feedback loop of a switching regulator that is capable of providing effective pole cancellation and zero compensation while being simple to implement. FIG. 3 duplicates FIG. 3 of the '264 patent and illustrates a compensation circuit in a monolithic switching regulator controller being incorporated in a closed loop feedback system of a switching regulator.

The compensation circuit of the '264 patent includes an amplifier having a non-inverting input terminal coupled to the feedback terminal for receiving the feedback voltage, an inverting input terminal coupled to a COMP terminal of the switching regulator controller, and an output terminal. A resistor R_{zero} is connected between the inverting input terminal and the output terminal of the amplifier. A resistor R_{IN} is connected between the output terminal of the amplifier and a first input terminal of the error amplifier of the switching regulator controller where the first input terminal receiving the signal indicative of the feedback voltage. A capacitor Cₚₒₗₑ and a resistor R_{f} are connected in series between the first input terminal and an output terminal of the error amplifier where the output terminal of the error amplifier providing the error output voltage. The capacitor Cₚₒₗₑ and the resistor R_{f} operate to introduce a first zero in the closed loop feedback system.

When a capacitor C_{zero} is coupled to the COMP terminal of the switching regulator controller, a second zero is introduced in the closed loop feedback system. In the '264 patent, the capacitor C_{zero} is an off-chip capacitor formed external to the monolithic switching regulator controller.

### SUMMARY OF THE INVENTION

According to one embodiment of the present invention, a compensation circuit in a monolithic switching regulator controller being incorporated in a closed loop feedback system of a switching regulator is described. The switching regulator controller includes an input terminal receiving an input voltage, an output terminal providing a switching output voltage corresponding to a regulated output voltage, and a feedback terminal for receiving a feedback voltage corresponding to the regulated output voltage. The compensation circuit includes an error amplifier comparing a signal indicative of the feedback voltage and a reference voltage and generating an error output voltage at an output terminal where the error amplifier having an output impedance at the output terminal. The error amplifier further includes a degeneration resistance terminal where a degeneration resistor is connected between the degeneration resistance terminal and a virtual ground node. The degeneration resistance terminal is coupled to a first terminal of the switching regulator controller. The compensation circuit further includes a first resistor and a first capacitor connected in series between the output terminal of the error amplifier and a ground potential. In operation, the first capacitor and the output impedance of the error amplifier operate to introduce a pole and the first resistor and the first capacitor operate to introduce a first zero in the closed loop feedback system.

In another embodiment, a second capacitor is to be coupled to the first terminal of the switching regulator controller. The second capacitor and the degeneration resistor of the error amplifier operate to introduce a second zero in the closed loop feedback system. The second capacitor is an off-chip capacitor formed external to the monolithic switching regulator controller.

According to another aspect of the present invention, a method for providing zero compensation in a monolithic switching regulator controller being incorporated in a closed loop feedback system of a switching regulator receiving an input voltage and providing a regulated output voltage includes receiving a feedback voltage at a first input terminal and a reference voltage at a second input terminal of an error amplifier where the feedback voltage corresponding to the regulated output voltage, generating an error output voltage at an output terminal of the error amplifier where the error amplifier having an output impedance at the output terminal, and coupling a first resistor and a first capacitor, connected in series, between the output terminal of the error amplifier and a ground potential. The first capacitor and the output impedance of the error amplifier operate to introduce a pole and the first resistor and the first capacitor operate to introduce a first zero in the closed loop feedback system.

In another embodiment, the method further includes coupling a degeneration resistance terminal of the error amplifier to a first terminal of the switching regulator controller where a degeneration resistor in the error amplifier is connected between the degeneration resistance terminal and a virtual ground node; and coupling a second capacitor to the first terminal of the switching regulator controller where the second capacitor is an off-chip capacitor formed external to the monolithic switching regulator controller. The second capacitor and the degeneration resistor of the error amplifier operate to introduce a second zero in the closed loop feedback system.

The present invention is better understood upon consideration of the detailed description below and the accompanying drawings.

### BRIEF DESCRIPTION OF THE DRAWINGS

FIG. 1 illustrates one approach for providing compensation in a feedback control loop of a switching regulator.

FIG. 2 is a plot of the loop gain magnitude vs. frequency in log scale for the switching regulator of FIG. 1.

FIG. 3 duplicates FIG. 3 of the '264 patent and illustrates a compensation circuit in a monolithic switching regulator controller being incorporated in a closed loop feedback system of a switching regulator.

FIG. 4 is a schematic diagram of a switching regulator including a monolithic switching regulator controller implementing the compact zero compensation scheme according to one embodiment of the present invention.

FIG. 5 is a circuit diagram of an error amplifier circuit which can be used to implement the error amplifier in the monolithic switching regulator controller of FIG. 4.

FIG. 6 is a plot of the loop gain magnitude vs. frequency in log scale for the switching regulator of FIG. 4.

FIG. 7 is a loop gain vs. frequency plot for the feedback system of the switching regulator in FIG. 4 with different values of capacitance for capacitor C_{zero.}

FIG. 8 is a schematic diagram of a switching regulator including a monolithic switching regulator controller implementing the compact zero compensation scheme according to a second embodiment of the present invention.

FIG. 9 is a loop gain vs. frequency plot for the feedback system of the switching regulator in FIG. 8.

FIG. 10 is a schematic diagram of a switching regulator including a monolithic switching regulator controller implementing the compact zero compensation scheme according to a third embodiment of the present invention.

FIG. 11 is a loop gain vs. frequency plot for the feedback system of the switching regulator in FIG. 10.

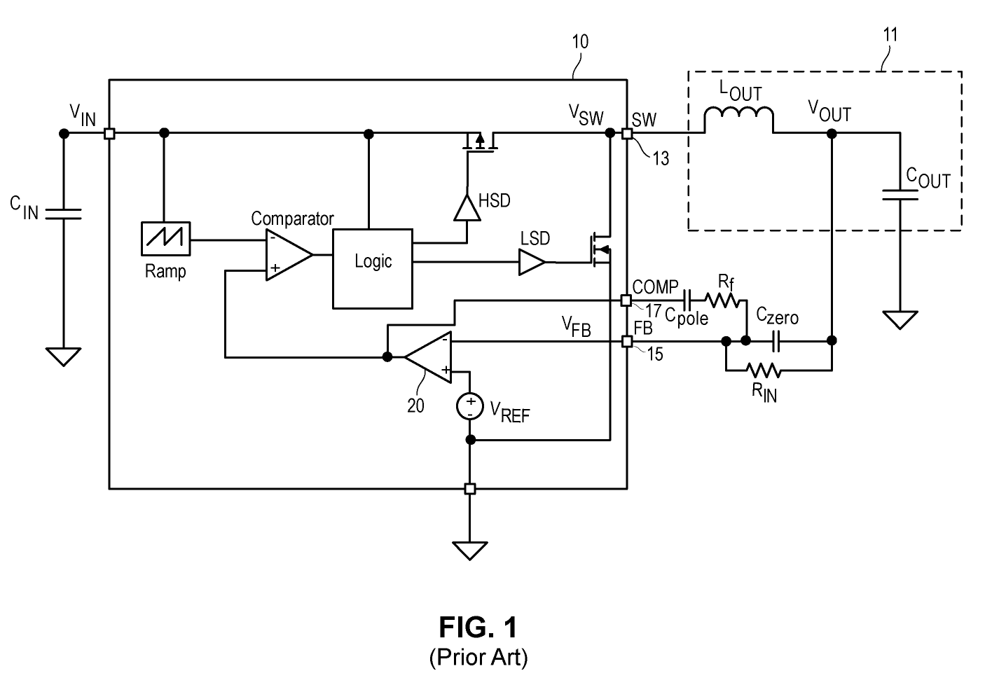

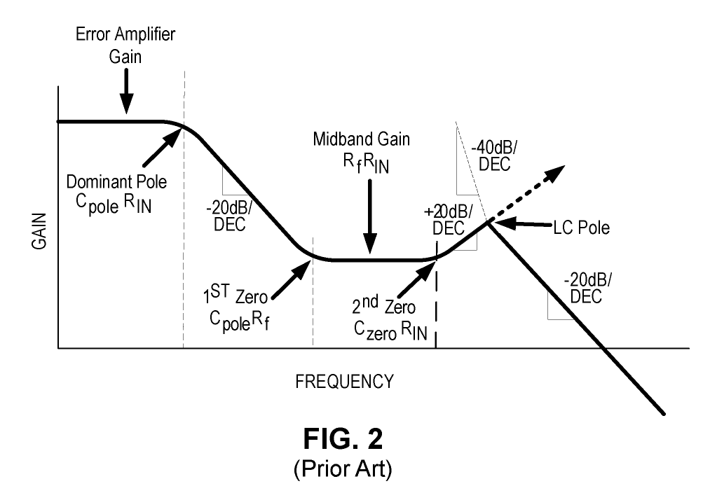

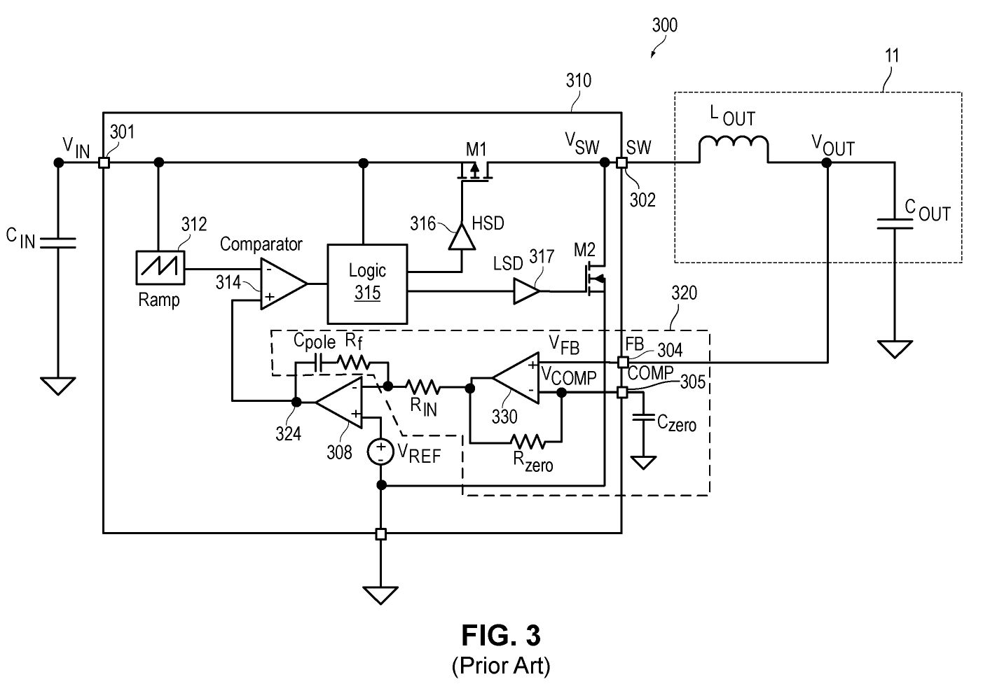

### DETAILED DESCRIPTION OF THE PREFERRED EMBODIMENTS

In accordance with the principles of the present invention, a zero compensation scheme for implementing type III compensation in a switching regulator includes an on-chip compensation circuit which can be coupled to an off-chip zero capacitor for providing frequency compensation to improve close loop stability. The on-chip compensation circuit is coupled to and incorporated with the error amplifier of the switching regulator controller and utilizes the resistance inherent in the error amplifier to establish a first pole while the on-chip compensation circuit provides a first zero for the feedback loop. Furthermore, an external zero capacitor is coupled to the degeneration resistance terminal of the error amplifier to establish a second zero for the feedback loop. In this manner, a simple type III compensation scheme is realized where the location of the first zero is fixed on-chip and the location of the second zero is varied by selecting a single external component—the zero capacitor.

In another embodiment, the zero compensation scheme of the present invention is applied to implement type II compensation by not using the off-chip zero capacitor. The simple type II compensation is realized where the internal zero provides the necessary compensation for frequency stability. In yet another embodiment of the present invention, a RC network can be connected in parallel with the external zero capacitor C_{zero}. The RC network operates to modify the loop gain of the feedback loop of the switching regulator.

The zero compensation circuit and method of the present invention realizes the same advantages as the zero compensation circuit of the '264 patent. First, the zero compensation circuit of the present invention is simple for the user to implement as the user only needs to select a single component value—the zero capacitor—to realize effective Type III compensation. Second, by allowing the location of the second zero to be established through an external component, the compensation scheme allows for a wide range of inductor and capacitor values to be selected for the output filter circuit of the switching regulator. In general, the zero compensation circuit of the present invention provides a simplified approach for close loop compensation while providing flexibility for selecting inductance and capacitance values for the output filter circuit. Third, the zero compensation circuit and method of the present invention can be effectively applied in switching voltage regulators and other closed loop feedback systems with multiple poles for introducing effective “zero” compensation and improving frequency stability.

Furthermore, the zero compensation circuit of the present invention has advantages over the prior art solutions by using reduced circuitry as compared to the compensation circuit of the '264 patent, thereby lowering the manufacturing cost. The zero compensation circuit of the present invention is capable of realizing a more stable transfer characteristic due to the reduced number of circuit elements and circuit complexity as compared to prior art solutions.

In the present description, a “zero” and a “pole” have meanings well understood by one skilled in the art. Specifically, a “zero” refers to the complex frequency at which the frequency response of a linear circuit has a zero amplitude, and a “pole” refers to the complex frequency at which the frequency response of a linear circuit has an infinite amplitude. In a feedback system, a pole signifies the frequency at which gain reduction begins while a zero signifies the frequency at which gain increase starts.

The zero compensation circuit of the present invention realizes type III compensation. Type III compensation is widely used for voltage-mode control because of its design flexibility. The generic transfer function of an ideal error amplifier with type III compensation is defined by equation (1) as follows:

$$W 1 ( s ) = \frac{( - a ( s ) \times Z 1 )}{( Z 1 + Z 2 + a ( s ) \times Z 2 )} \qquad ( 1 )$$

The variable “a(s)” in equation (1) is the frequency response of the non-ideal error amplifier itself and “Z1” and “Z2” are the compensation circuit impedances. The type III compensation scheme has a pole at the origin (from the integrator) that ensures high DC gain and resulting low output-voltage error of the converter. Additionally, a pair of zeros provides the required phase boost near resonant frequency thus allowing for increased bandwidth of the feedback loop.

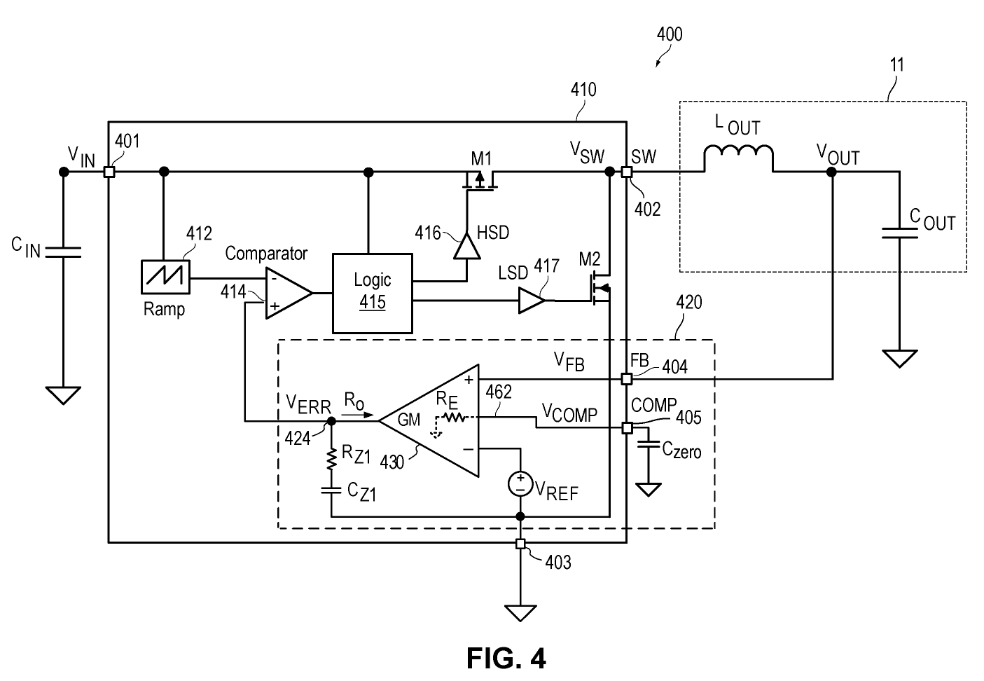

FIG. 4 is a schematic diagram of a switching regulator including a monolithic switching regulator controller implementing the compact zero compensation scheme according to one embodiment of the present invention. Referring to FIG. 4, a switching regulator 400 includes a monolithic switching regulator controller 410, an input capacitor C_{IN} and an output LC filter circuit 11. Switching regulator controller 410 is formed on a single integrated circuit and the input capacitor and the output LC filter circuit are formed external to the integrated circuit. The circuitry of switching regulator controller 410 is conventional except for the zero compensation circuit 420 incorporated with the error amplifier 430 of the switching regulator controller. Switching regulator controller 410 receives an input voltage V_{IN} provided on an input terminal 401 and generates a switching output voltage V_{SW} on an output terminal (SW) 402. The switching output voltage V_{SW} is coupled to LC filter circuit 11 to generate an output voltage V_{OUT} having substantially constant voltage magnitude.

Switching regulator 400, constructed using controller 410 and LC circuit 11, forms a closed loop feedback system for regulating the switching output voltage V_{SW} and consequently, the regulated output voltage V_{OUT}. The output voltage V_{OUT} from LC filter circuit 11 is fed back to controller 410 on a feedback terminal (FB) 404. In some applications, the output voltage V_{OUT} may be coupled to a voltage divider to generate a stepped-down feedback voltage to be fed back to the feedback terminal. Alternately, the output voltage V_{OUT} can be fed back to controller 410 and then stepped down by an on-chip voltage divider formed in the controller integrated circuit. The use of external (off-chip) or internal (on-chip) voltage dividers to step down the output voltage V_{OUT} where needed is well known in the art. Thus, the feedback voltage V_{FB} can be the output voltage V_{OUT} or a stepped-down version of the output voltage V_{OUT}.

The feedback voltage V_{FB} is coupled to the control circuitry of controller 410. In FIG. 4, the control circuitry of controller 410 includes an error amplifier 430 receiving the feedback voltage V_{FB} on a non-inverting input terminal and a reference voltage V_{REF} on an inverting input terminal. Error amplifier 430 generates an error output voltage V_{ERR} on an output terminal 424 indicative of the difference between the feedback voltage V_{FB} and the reference voltage V_{REF}. In the present embodiment, error amplifier 430 is a transconductance amplifier (gₘ amplifier).

The error output voltage V_{ERR} of error amplifier 430 is coupled to a comparator 414 to be compared with a ramp voltage generated by a PWM ramp generator 412. The output of comparator 414 is coupled to drive a logic circuit 415 to generate the control signals for driving the switching transistors M1 and M2. Specifically, logic circuit 415 provides a control signal to drive a high-side driver (HSD) 416 which in turn drives a PMOS power transistor M1. Logic circuit 415 also provides a control signal to drive a low-side driver (LSD) 417 which in turn drives an NMOS power transistor M2. The schematic diagram of FIG. 4 is simplified to better illustrate the principles of the present invention. It is understood by one skilled in the art that, in actual implementation, switching regulator controller 410 may include additional terminals and circuitry for the specific application.

In the present embodiment, a zero compensation circuit 420 is incorporated in controller 410 to introduce an internal (on-chip) zero and an external (off-chip) zero to the feedback loop of switching regulator 400. In this manner, the zero compensation circuit of the present invention functions to ensure that the feedback system of the switching regulator meets the Nyquist criterion for frequency stability. Furthermore, the zero compensation circuit of the present invention is incorporated with the error amplifier 430 that is already present in the control circuitry of the switching regulator controller 410. Therefore, the zero compensation circuit of the present invention does not require any separate amplifier circuits and can be implemented using minimal components.

More specifically, zero compensation circuit 420 includes a resistor R_{Z1} and a capacitor C_{Z1} connected in series between the output terminal 424 of error amplifier 430 and ground (node 403). Capacitor C_{Z1} operates with the output resistance R_{O} of error amplifier 430 to introduce a first pole to the feedback loop of the switching regulator 400. The output resistance R_{O} represents the output impedance of the non-ideal error amplifier 430. A non-ideal error amplifier typically has a large and finite output impedance. Furthermore, resistor R_{Z1} and capacitor C_{Z1} together introduce a first zero to the feedback loop.

To complete the zero compensation circuit, a degeneration resistance terminal 462 of error amplifier 430 is brought out of the error amplifier circuit and is coupled to a compensation (COMP) terminal 405 to which a zero capacitor C_{zero}, external to the switching regulator controller integrated circuit, can be coupled. More specifically, zero capacitor C_{zero} is connected between the COMP terminal 405 and the ground potential. In accordance with the present invention, zero capacitor C_{zero} operates with the degeneration resistor R_{E} of error amplifier 430 to introduce a second zero to the feedback loop of the switching regulator 400.

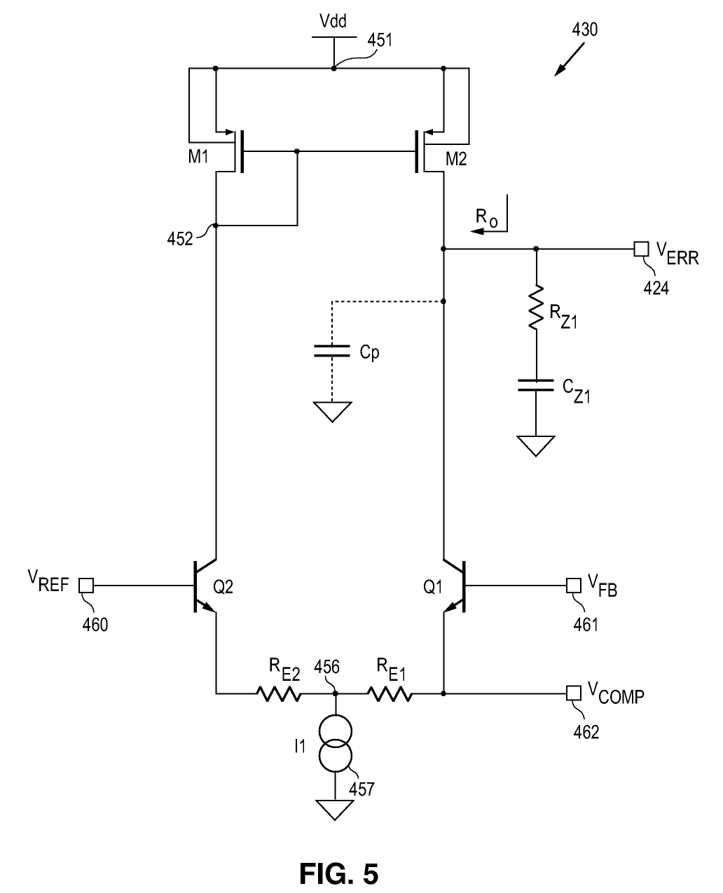

FIG. 5 is a circuit diagram of an error amplifier circuit which can be used to implement the error amplifier in the monolithic switching regulator controller of FIG. 4. Referring to FIG. 5, error amplifier 430 includes a pair of NPN bipolar transistors Q1 and Q2 forming a differential pair. The reference voltage V_{REF} is coupled to the base terminal (node 460) of transistor Q2 while the feedback voltage V_{FB} is coupled to the base terminal (node 461) of transistor Q1. The emitter terminals of transistors Q1 and Q2 are connected to respective degeneration resistors R_{E1} and R_{E2}. Resistors R_{E1} and R_{E2} have the same resistance and each is also referred to as a degeneration resistor R_{E}. Resistors R_{E1} and R_{E2} are connected to a common node 456 which is biased by a current source 457 providing a current I1. Common node 456 is therefore a virtual ground node and resistors R_{E1} and R_{E2} can be treated as being connected between the respective emitter terminal of transistors Q1 and Q2 and a virtual ground. Degeneration resistors R_{E1} and R_{E2} has the effect of reducing the gain of error amplifier circuit 430.

In accordance with the present invention, the terminal of degeneration resistor R_{E1} that is coupled to the emitter terminal of transistor Q1 is brought out of the error amplifier as the degeneration resistance terminal 462 of error amplifier 430. The degeneration resistance terminal 462 is to be coupled to the compensation terminal COMP 405 to which the zero capacitor C_{zero} can be connected. Zero capacitor C_{zero}, when provided, and resistor R_{E1} together introduce a zero the feedback loop of switching regulator 400.

In error amplifier 430, transistors Q1 and Q2 are biased by a current mirror formed by PMOS transistors M1 and M2. More specifically, transistor M1 is diode-connected and has a source terminal connected to the positive power supply Vdd voltage (node 451) and gate and drain terminal connected together (node 452) and to the collector terminal of transistor Q2. Transistor M2 has its gate terminal connected to the gate terminal of transistor M1, its source terminal connected to the positive power supply voltage Vdd, and its drain terminal (node 424) connected to the collector terminal of transistor Q1. The collector terminal (node 424) of transistor Q1 forms the output terminal of error amplifier 430. The output impedance R_{O} of error amplifier 430 is the impedance looking into the output terminal 424 of the amplifier. The output impedance R_{O} of error amplifier 430 may include a parasitic capacitance component represented by parasitic capacitor Cp. In FIG. 5, resistor R_{Z1} and capacitor C_{Z1} are added to show the connection of the resistor and capacitor to the output terminal 424 of error amplifier 430. It is understood that resistor R_{Z1} and capacitor C_{Z1} do not form part of the output impedance R_{O} of error amplifier 430.

FIG. 5 illustrates one embodiment of the error amplifier circuit which may be used in the switching regulator controller of FIG. 4. Error amplifier circuit 430 shown in FIG. 5 is illustrative only and is not intended to be limiting. Other amplifier circuitry can be used to implement error amplifier circuit 430 as long as a degeneration resistance terminal can be brought out of the amplifier circuit. In an alternate embodiment of the present invention, error amplifier circuit 430 is implemented using NMOS transistors as the differential pair. The configuration and operation of the error amplifier circuit with an NMOS differential pair is the same as the error amplifier circuit of FIG. 5 with the NMOS differential pair replacing the NPN bipolar differential pair.

In the feedback loop of switching regulator 400, the LC filter circuit 11 introduces two poles to the feedback loop which needs to be compensated. The zero compensation circuit of the present invention provides a first zero which is formed internal (on-chip) of the switching regulator controller integrated circuit and a second zero which is formed external (off-chip) to the switching regulator controller integrated circuit. More specifically, the output resistance Ro of error amplifier 430 and capacitor C_{Z1} of zero compensation circuit 420 introduce a dominant pole at error amplifier 430 while capacitor C_{Z1} and resistor R_{Z1} introduces the first zero at the error amplifier 430. The locations of the dominant pole and the first zero are thereby fixed by nature of the capacitor and resistors being formed as part of the controller integrated circuit. The second zero is introduced to the feedback loop by coupling an off-chip zero capacitor C_{zero} to the COMP input terminal 405. The location of the second zero can thus be modified by selecting the appropriate capacitance value for the zero capacitor C_{zero}.

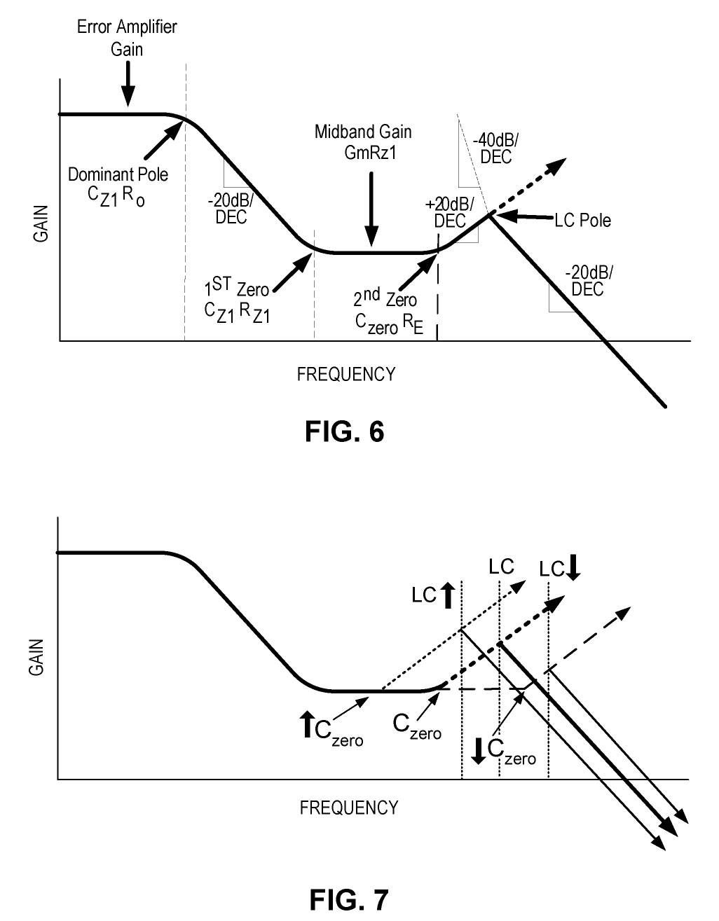

FIG. 6 is a plot of the loop gain magnitude vs. frequency in log scale for the switching regulator of FIG. 4. Referring to FIG. 6, the low frequency loop gain is first reduced by a dominant pole associated with capacitor C_{Z1} and the output resistance R_{O} of error amplifier 430. The gain loss is modified by the first zero also associated with capacitor C_{Z1} and resistor R_{Z1} to form a midband gain region. The midband gain region is also a function of the transconductance (gₘ) of error amplifier input stage. Then, at high frequency, the second zero associated with capacitor C_{zero} and the degeneration resistor R_{E} of error amplifier 430 becomes effective to increase the gain until the effect of the double-pole in the LC filter circuit causes a large loss in the loop gain. The operation of the zero capacitor C_{zero} ensures that the phase shift of the feedback loop is less than 180° near unity gain.

In accordance with the present invention, the capacitance value of zero capacitor C_{zero} is selected to modify the location of the second zero in the feedback loop. FIG. 7 is a loop gain vs. frequency plot for the feedback system of the switching regulator in FIG. 4 with different values of capacitance for capacitor C_{zero}. The loop gain vs. frequency plot of FIG. 7 is similar to that of FIG. 6 in that the low frequency loop gain is first reduced by a dominant pole associated with capacitor C_{Z1} and resistance R_{O} and then the gain loss is modified by the first zero also associated with capacitor C_{Z1} and resistor R_{Z1} to form a midband gain region. Then, as shown in FIG. 7, the location of the second zero associated with zero capacitor C_{zero} and resistance R_{E} can be modified by changing the capacitance value of the externally coupled zero capacitor C_{zero}. In this manner, the location of the second zero can be changed to accommodate different inductor and capacitor values used for the LC filter circuit. For instance, when larger inductor and capacitor values are used for the LC filter circuit, a larger zero capacitor C_{zero} can be used to decrease the second zero frequency. On the other hand, when smaller inductor and capacitor values are used for the LC filter circuit, a smaller zero capacitor C_{zero} can be used to increase the second zero frequency accordingly so that close loop stability is maintained. Thus, a user only needs to select one component value—the zero capacitor C_{zero}—to realize effective compensation of the switching regulator for a wide range of inductor and capacitor values used for the LC filter circuit.

In accordance with the compensation scheme of the present invention, the compensation circuit couples the zero capacitor C_{zero} to the degeneration resistance terminal of error amplifier 430 to incorporate the external zero in the feedback loop. Coupling zero capacitor C_{zero} through error amplifier 430 enables the use of a zero capacitor C_{zero} with practical capacitance value. In one embodiment, capacitor C_{Z1} is about 120 pf and resistor R_{A1} is about 100 kohms. For output capacitance value C_{OUT} of 10 μF and for output inductance values LOUT across one order of magnitude change (e.g. 0.5 μH to 5 μH), the capacitance value for zero capacitor C_{zero} can be from 20 pf to 100 pf. With these inductance and capacitance values, a constant phase margin of 36 degrees is maintained. By allowing a large capacitance value to be used as zero capacitor C_{zero}, the user of switching regulator 400 is provided with more control over the capacitance value of zero capacitor C_{zero} and therefore the user has effective control over the location of the second zero in the feedback loop.

In some applications, the output capacitor C_{OUT} used in the LC filter circuit has a low equivalent series resistance (ESR). For example, a ceramic capacitor may be used to form the output capacitor C_{OUT}. In that case, Type III compensation requiring first and second zeroes is necessary to compensate for the double pole of the LC filter circuit. The zero compensation scheme described with reference to FIG. 4 utilizes an off-chip zero capacitor to introduce a second zero with selectable frequency location to realize a Type III compensation scheme. However, in some other applications, a capacitor with a high ESR may be used as the output capacitor C_{OUT}. For example, a tantalum or electrolytic capacitor may be used and such capacitors have appreciable ESR. When the output capacitor C_{OUT} has a high ESR, the resistance in the output capacitor introduces a zero itself so that the switching regulator requires only type II compensation to achieve frequency stability.

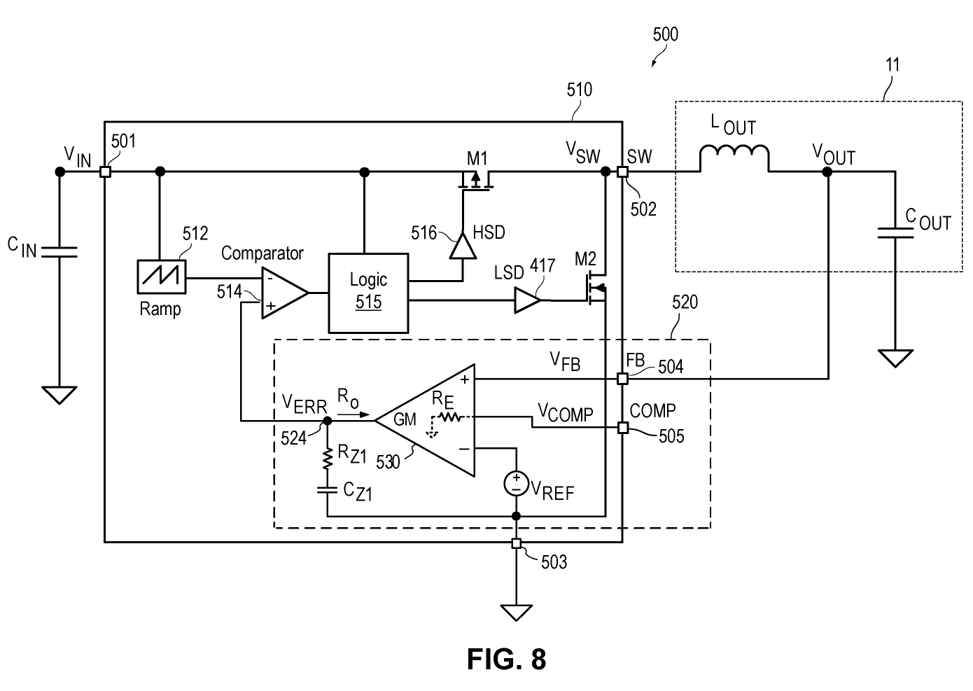

According to another aspect of the present invention, the zero compensation scheme of the present invention is applied in a switching regulator to implement type II compensation. FIG. 8 is a schematic diagram of a switching regulator including a monolithic switching regulator controller implementing the zero compensation scheme according to a second embodiment of the present invention. In the embodiment shown in FIG. 8, the output capacitor C_{OUT} of switching regulator 500 is implemented using a high ESR capacitor, such as a tantalum or electrolytic capacitor. Because of the high ESR, the output capacitor C_{OUT} provides a zero itself to the feedback loop. Therefore, the switching regulator 500 requires only one additional zero. The zero compensation circuit 520 of the present invention can thus be utilized by leaving the COMP input terminal unconnected. That is, no external zero capacitor needs to be connected to the COMP input terminal of zero compensation circuit 520. Zero compensation circuit 520 provides an internal (on-chip) zero to the feedback loop through capacitor C_{Z1} and resistor R_{Z1}.

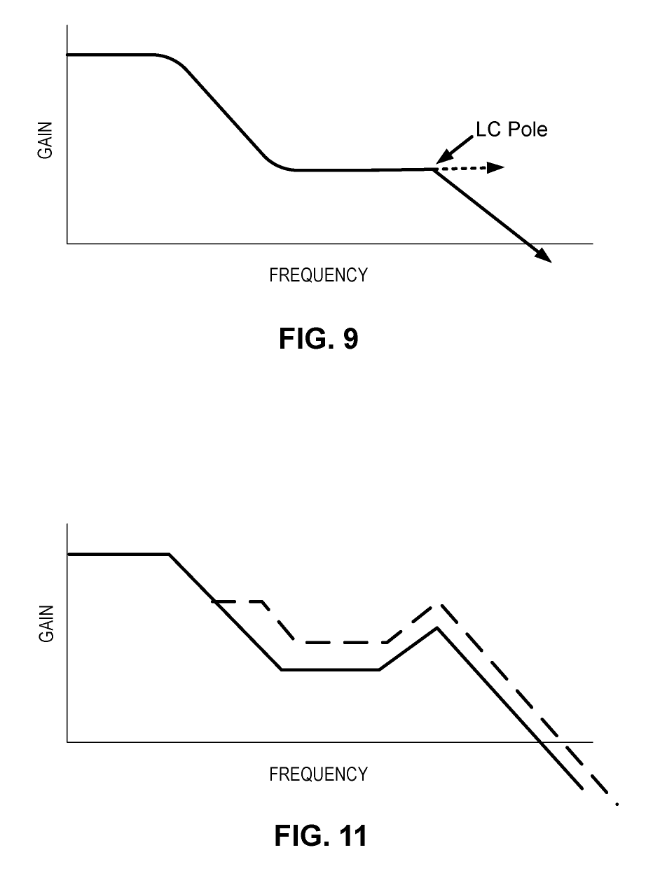

FIG. 9 is a loop gain vs. frequency plot for the feedback system of the switching regulator in FIG. 8. As shown in FIG. 9, the loop gain is reduced by dominant pole and is modified by the first zero at the midband gain region. Then, there is no second zero but instead the loop gain is reduced by the double pole of the output filter circuit. Because the output capacitor C_{OUT} provides a zero, the slope of the LC double pole is tapered so that there is sufficient phase margin in the loop gain at unity gain.

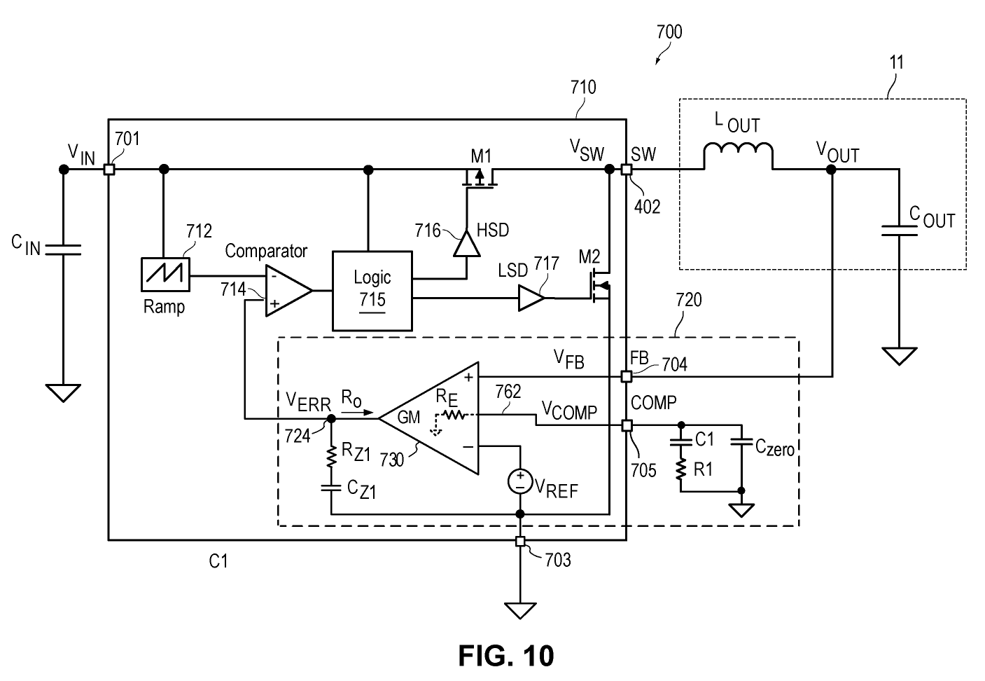

According to yet another aspect of the present invention, an external (off-chip) RC network can be coupled in parallel with the off-chip zero capacitor to modify the loop gain, in particular the mid-band gain, of the feedback loop of the switching regulator. FIG. 10 is a schematic diagram of a switching regulator including a monolithic switching regulator controller implementing the zero compensation scheme according to a third embodiment of the present invention. Switching regulator 700 in FIG. 10 incorporates a zero compensation circuit in the same manner as switching regulator 400 of FIG. 4 and like elements in FIGS. 4 and 10 are given like reference numerals to simplify the discussion.

In switching regulator 700, the zero compensation circuit 720 includes a zero capacitor C_{zero} coupled to the COMP input terminal 705 which connects to the degeneration resistance terminal 762 of error amplifier 730. Zero capacitor C_{zero} provides an external zero to the feedback loop. Furthermore, an RC network, including a serial connection of a capacitor C1 and a resistor R1, is coupled between the COMP input terminal 705 and the ground potential. Thus, the RC network is connected in parallel with zero capacitor C_{zero}. The RC network of capacitor C1 and resistor R1 operates to modify the loop gain of the feedback loop of switching regulator 700.

More specifically, the RC network operates to modify the loop gain at a specific frequency location as determined by the resistance and capacitance values of resistor R1 and capacitor C1 in the RC network. FIG. 11 is a loop gain vs. frequency plot for the feedback system of the switching regulator in FIG. 10. As shown in FIG. 11, the addition of the RC network increases the loop gain around the midband region. In other embodiments, the RC network may include a single resistor to increase the entire loop gain of switching regulator.

The above detailed descriptions are provided to illustrate specific embodiments of the present invention and are not intended to be limiting. Numerous modifications and variations within the scope of the present invention are possible. The present invention is defined by the appended claims.

We claim:

1. A compensation circuit in a monolithic switching regulator controller being incorporated in a closed loop feedback system of a switching regulator, the switching regulator controller including an input terminal receiving an input voltage, an output terminal providing a switching output voltage corresponding to a regulated output voltage, and a feedback terminal for receiving a feedback voltage corresponding to the regulated output voltage, the compensation circuit comprising:
an error amplifier comparing a signal indicative of the feedback voltage and a reference voltage and generating an error output voltage at an output terminal, the error amplifier having an output impedance at the output terminal, the error amplifier comprising a degeneration resistance terminal, a degeneration resistor being connected between the degeneration resistance terminal and a virtual ground node, the degeneration resistance terminal being coupled to a first terminal of the switching regulator controller; and
a first resistor and a first capacitor connected in series between the output terminal of the error amplifier and a ground potential,
wherein the first capacitor and the output impedance of the error amplifier operate to introduce a pole and the first resistor and the first capacitor operate to introduce a first zero in the closed loop feedback system.

2. The compensation circuit of claim 1, wherein a second capacitor is to be coupled to the first terminal of the switching regulator controller, the second capacitor and the degeneration resistor of the error amplifier operate to introduce a second zero in the closed loop feedback system, the second capacitor being an off-chip capacitor formed external to the monolithic switching regulator controller.

3. The compensation circuit of claim 1, wherein the output terminal of the switching regulator controller is coupled to an output filter circuit for generating the regulated output voltage, the output filter circuit comprising an inductor and a third capacitor connected in series between the output terminal of the switching regulator controller and the ground potential, wherein the third capacitor comprises a capacitor with a high equivalent series resistance (ESR).

4. The compensation circuit of claim 3, wherein the third capacitor comprises a tantalum capacitor or an electrolytic capacitor.

5. The compensation circuit of claim 2, wherein the output terminal of the switching regulator controller is coupled to an output filter circuit for generating the regulated output voltage, the output filter circuit comprising an inductor and a third capacitor connected in series between the output terminal of the switching regulator controller and a ground potential, wherein the third capacitor comprises a capacitor with a low equivalent series resistance (ESR).

6. The compensation circuit of claim 5, wherein the third capacitor comprises a ceramic capacitor.

7. The compensation circuit of claim 5, wherein the capacitance of the second capacitor is selected in accordance with the inductance of the inductor and the capacitance of the third capacitor of the output filter circuit.

8. The compensation circuit of claim 7, wherein when the inductance of the inductor and the capacitance of the third capacitor of the output filter circuit have large values, the capacitance of the second capacitor increases correspondingly to decrease the frequency of the second zero; and when the inductance of the inductor and the capacitance of the third capacitor of the output filter circuit have small values, the capacitance of the second capacitor decreases correspondingly to increase the frequency of the second zero.

9. The compensation circuit of claim 2, wherein a second resistor is to be coupled in parallel with the second capacitor to increase the gain of the closed loop feedback system.

10. The compensation circuit of claim 2, wherein a fourth capacitor and a second resistor, connected in series, are to be coupled in parallel with the second capacitor to increase the gain of the closed loop feedback system at a frequency determined by the capacitance of the fourth capacitor and the resistance of the second resistor.

11. A method for providing zero compensation in a monolithic switching regulator controller being incorporated in a closed loop feedback system of a switching regulator receiving an input voltage and providing a regulated output voltage, the method comprising:
receiving a feedback voltage at a first input terminal and a reference voltage at a second input terminal of an error amplifier, the feedback voltage corresponding to the regulated output voltage;
generating an error output voltage at an output terminal of the error amplifier, the error amplifier having an output impedance at the output terminal; and
coupling a first resistor and a first capacitor, connected in series, between the output terminal of the error amplifier and a ground potential, wherein the first capacitor and the output impedance of the error amplifier operate to introduce a pole and the first resistor and the first capacitor operate to introduce a first zero in the closed loop feedback system.

12. The method of claim 11, further comprising:
coupling a degeneration resistance terminal of the error amplifier to a first terminal of the switching regulator controller, wherein a degeneration resistor in the error amplifier is connected between the degeneration resistance terminal and a virtual ground node; and
coupling a second capacitor to the first terminal of the switching regulator controller, the second capacitor being an off-chip capacitor formed external to the monolithic switching regulator controller, wherein the second capacitor and the degeneration resistor of the error amplifier operate to introduce a second zero in the closed loop feedback system.

13. The method of claim 11, further comprising:
coupling an output filter circuit to the switching regulator controller to generate the regulated output voltage, the output filter circuit comprising an inductor and a third capacitor being a capacitor with a high equivalent series resistance (ESR).

14. The method of claim 13, wherein the third capacitor comprises a tantalum capacitor or an electrolytic capacitor.

15. The method of claim 12, further comprising:
coupling an output filter circuit to the switching regulator controller to generate the regulated output voltage, the output filter circuit comprising an inductor and a third capacitor being a capacitor with a low equivalent series resistance (ESR).

16. The method of claim 15, wherein the third capacitor comprises a ceramic capacitor.

17. The method of claim 15, wherein the capacitance of the second capacitor is selected in accordance with the inductance of the inductor and the capacitance of the third capacitor of the output filter circuit.

18. The method of claim 17, wherein when the inductance of the inductor and the capacitance of the third capacitor of the output filter circuit have large values, the capacitance of the second capacitor increases correspondingly to decrease the frequency of the second zero; and when the inductance of the inductor and the capacitance of the third capacitor of the output filter circuit have small values, the capacitance of the second capacitor decreases correspondingly to increase the frequency of the second zero.

19. The method of claim 12, further comprising:
coupling a second resistor in parallel with the second capacitor to increase the gain of the closed loop feedback system.

20. The method of claim 12, further comprising:
coupling a fourth capacitor and a second resistor, connected in series, in parallel with the second capacitor to increase the gain of the closed loop feedback system at a frequency determined by the capacitance of the fourth capacitor and the resistance of the second resistor.
